(19) United States
(12) Patent Application Publication
(10) Pub. No.: US 2025/0080179 A1
(43) Pub. Date: Mar. 6, 2025

(54) COMMUNICATION DEVICE AND METHOD

(71) Applicant: NEC Corporation, Minato-ku, Tokyo (JP)

(72) Inventor: Tetsuhiko Miyatani, Tokyo (JP)

(73) Assignee: NEC Corporation, Minato-ku, Tokyo (JP)

(21) Appl. No.: 18/293,916

(22) PCT Filed: Dec. 17, 2021
(86) PCT No.: PCT/JP2021/046745

§ 371 Date: Jan. 31, 2024

(30) Foreign Application Priority Data
Sep. 17, 2021 (JP) 2021-151801

(51) Int. Cl. H04B 7/06

(52) U.S. Cl. CPC H04B 7/0617

(57) ABSTRACT

The present disclosure provides a communication device and a method that can easily achieve beam pattern monitoring. A parameter calculation unit of a communication device calculates a beam forming parameter each time information necessary for beam forming is received. A monitoring packet generation unit generates a monitoring packet including the beam forming parameter calculated by the parameter calculation unit and sends the monitoring packet to an interface.

### TECHNICAL FIELD

The present disclosure relates to a communication device and a method.

### BACKGROUND ART

Recently, in a mobile communication network employing New Radio (NR), a base station (BS) is divided into several devices. A base station employing NR is divided, for example, into a centralized unit (CU), a distributed unit (DU), and a radio unit (RU). Among these units, for example, the CU hosts a packet data convergence protocol (PDCP) layer. The DU hosts, for example, a radio link control (RLC) layer, a media access control (MAC) layer, and an upper part (high PHY layer) among physical (PHY) layers. The RU hosts, for example, a lower part (low PHY layer) among PHY layers. The DU and the RU are connected via an interface referred to as a fronthaul. When a base station is constituted of devices such as a CU, a DU, and an RU, an approach to an open radio access network (Open RAN) in which devices based on different vendors are combined and a base station is configured is being accelerated. Open RAN is employed, and thereby a CU, a DU, an RU, and the like that are conventionally provided by a single vendor can be combined more flexibly. Currently, “O-RAN Alliance” being an industry organization acts as a center and is advancing formulation of a specification of O-RAN being one of specifications of Open RAN. In a case of a RAN architecture employing O-RAN, a DU employing O-RAN is referred to as an O-DU and an RU employing O-RAN is referred to as an O-RU in some cases. NPL 1, for example, describes O-RAN and an architecture of an O-DU and an O-RU.

In the present time in which communication terminals (e.g., user equipment (UE)) are explosively increasing, it is common that a beam forming technique using a large-scale array antenna included in a base station is used. The beam forming technique is effectively used, and thereby high-speed and large-capacity radio communication in NR is made possible. When, for example, a base station divided into a CU, a DU, and an RU performs communication using beam forming, a beam forming technique described, for example, in NPL 2 is used.

### CITATION LIST

### Non Patent Literature

NPL 1: O-RAN Fronthaul Control, User and Synchronization Plane Specification 6.0—March 2021
NPL 2: Kazuaki Takeda and five others, “A Study Status regarding a Physical Layer Element Technique and High-frequency Band Use in 5G”, NTT DOCOMO Technical Journal, Vol. 25, No. 3, October 2017, the Internet <URL: https://www.nttdocomo.co.jp/binary/pdf/corporate/technology/rd/technical_journal/bn/vol25_3/vol25_3_005jp.pdf>

### SUMMARY OF INVENTION

### Technical Problem

When a beam pattern formed by an RU is confirmed, for example, by using a large-scale radio wave anechoic chamber or an expensive measurement instrument, a beam pattern being output from an antenna is measured, or a device performing debugging on a base station is connected to a base station and data in the base station are extracted. However, a base station is frequently installed at high altitude, and therefore it is difficult to carry a base station installed once to a radio wave anechoic chamber and measure a beam pattern, and extract, by using the above-described method, data of a base station installed at high altitude.

In view of the above-described problems, an object of the present disclosure is to provide a communication device and a method that are capable of easily achieving beam pattern monitoring.

### Solution to Problem

A communication device according to one aspect of the present disclosure is, between a first communication device and a second communication device that are connected to each other via an interface and include base station functions disposed in a distributed manner, the first communication device, and the first communication device includes: a reception means for receiving, via the interface, information necessary for beam forming from the second communication device; a parameter calculation means for calculating, each time information necessary for beam forming is received, based on the information necessary for beam pattern forming, a beam forming parameter for forming a beam to be used when a downlink signal received from the second communication device is transmitted to a terminal device; and a monitoring packet generation means for generating, each time a beam forming parameter is calculated, a monitoring packet including the calculated beam forming parameter and outputting the monitoring packet to the interface.

A communication device according to one aspect of the present disclosure is, between a first communication device and a second communication device that are connected to each other via an interface and include base station functions disposed in a distributed manner, the second communication device, and the second communication device includes a transmission means for transmitting, via the interface, information necessary for beam forming and a request for transmitting a monitoring packet, to the first communication device, wherein the monitoring packet includes a beam forming parameter for forming a beam to be used when a downlink signal is transmitted to a terminal device.

A method according to one aspect of the present disclosure is a method to be executed by, between a first communication device and a second communication device that are connected to each other via an interface and include base station functions disposed in a distributed manner, the first communication device, and the method includes: receiving, via the interface, information necessary for beam forming from the second communication device; calculating, each time information necessary for beam forming is received, based on the information necessary for beam pattern forming, a beam forming parameter for forming a beam to be used when a downlink signal received from the second communication device is transmitted to a terminal device; generating, each time a beam forming parameter is calculated, a monitoring packet including the calculated beam forming parameter; and outputting the monitoring packet to the interface.

A method according to one aspect of the present disclosure is a method to be executed by, between a first communication device and a second communication device that are connected to each other via an interface and include base station functions disposed in a distributed manner, the second communication device, wherein the second communication device transmits, to the first communication device, via the interface, information necessary for beam forming and a request for transmitting a monitoring packet, and the monitoring packet includes a beam forming parameter for forming a beam to be used when a downlink signal is transmitted to a terminal device.

### Advantageous Effects of Invention

According to the present disclosure, a communication device and a method that are capable of easily achieving beam pattern monitoring can be provided.

### BRIEF DESCRIPTION OF DRAWINGS

FIG. 1 is an illustrative diagram illustrating an example of a communication device 1 according to a first example embodiment.

FIG. 2 is an illustrative diagram illustrating an example of a communication device 2 according to the first example embodiment.

FIG. 3 is an illustrative diagram illustrating an example of a communication device 3 according to the first example embodiment.

FIG. 4 is a sequence diagram illustrating an operation example of the communication device 3 according to the first example embodiment.

FIG. 5 is an illustrative diagram illustrating an example of a communication device 5 according to a second example embodiment.

FIG. 6 is an illustrative diagram illustrating an example of a communication device 6 according to the second example embodiment.

FIG. 7 is an illustrative diagram illustrating an example of a communication device 7 according to the second example embodiment.

FIG. 8 is a sequence diagram illustrating an operation example of the communication device 7 according to the second example embodiment.

FIG. 9 is an illustrative diagram illustrating an example of a communication device 9 according to a third example embodiment.

FIG. 10 is an illustrative diagram illustrating an example of a communication device 10 according to the third example embodiment.

FIG. 11 is an illustrative diagram illustrating an example of a communication device 11 according to the third example embodiment.

FIG. 12 is a sequence diagram illustrating an operation example of the communication device 11 according to the third example embodiment.

FIG. 13 is an illustrative diagram illustrating an example of a communication device 13 according to a fourth example embodiment.

FIG. 14 is an illustrative diagram illustrating an example of a communication device 14 according to the fourth example embodiment.

FIG. 15 is an illustrative diagram illustrating an example of a communication device 15 according to the fourth example embodiment.

FIG. 16 is an illustrative diagram illustrating an example of a monitoring packet according to the fourth example embodiment.

FIG. 17 is an illustrative diagram illustrating an example of a beam pattern according to the fourth example embodiment.

FIG. 18 is a sequence diagram illustrating an operation example of the communication device 15 according to the fourth example embodiment.

FIG. 19 is an illustrative diagram illustrating a configuration example of a communication device according to each example embodiment.

### EXAMPLE EMBODIMENT

Hereinafter, specific example embodiments are described in detail with reference to the accompanying drawings. In the drawings, the same or a relevant element is assigned with the same reference sign, and in order to simplify description, overlapping description is omitted as necessary.

The following example embodiments can be implemented independently or can be implemented based on an appropriate combination. The plurality of example embodiments include new features different from each other. Therefore, the plurality of example embodiments contribute to solution to objects or problems different from each other and contribute to exhibition of advantageous effects different from each other.

When used in the present description, it may be recognized according to context that “if” means “when”, “at or around the time”, “after”, “upon”, “in response to determining”, “in accordance with a determination”, or “in response to detecting”. It may be recognized that these expressions have the same meaning according to context.

### First Example Embodiment

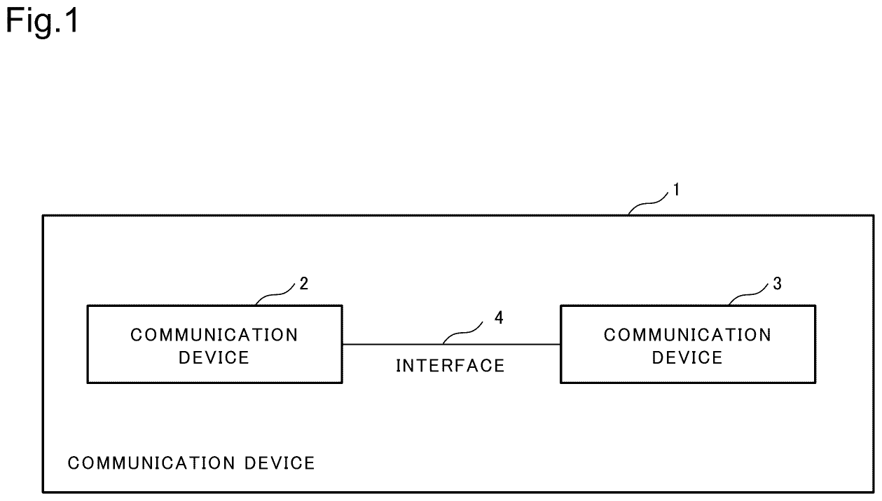

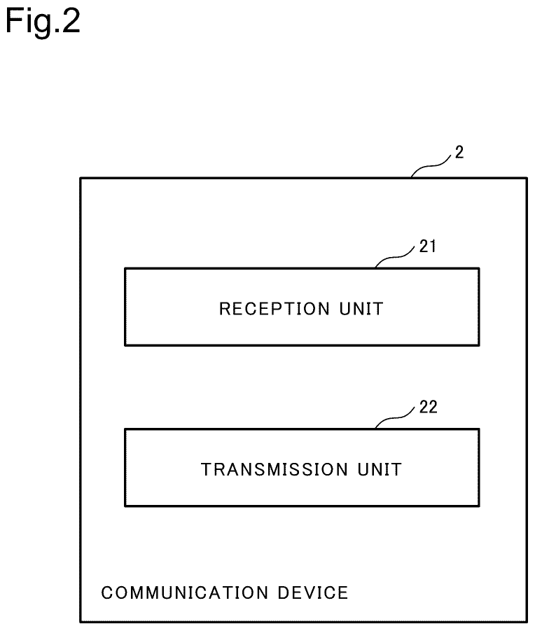

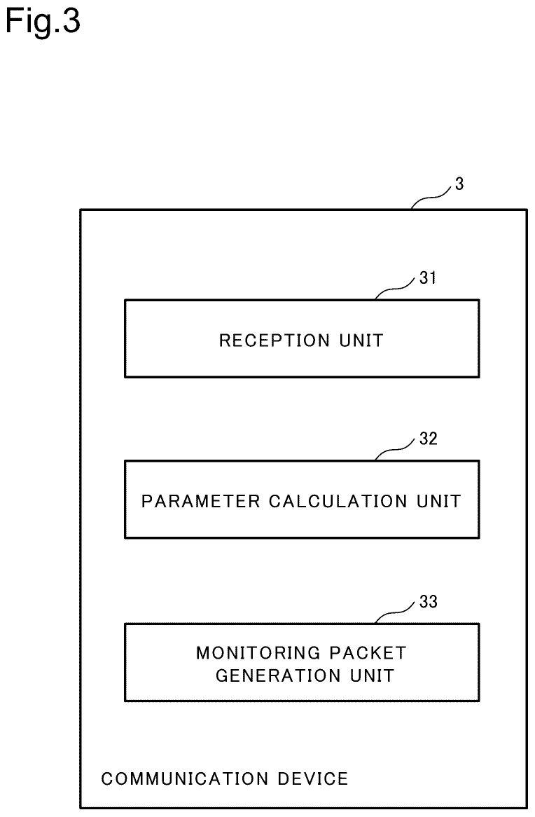

FIG. 1 illustrates a configuration example of a communication device 1 according to the present example embodiment, FIG. 2 illustrates a configuration example of a communication device 2 according to the present example embodiment, and FIG. 3 illustrates a configuration example of a communication device 3 according to the present example embodiment. Elements illustrated in FIG. 1, FIG. 2, and FIG. 3 can be mounted, for example, as dedicated hardware, software operating on dedicated hardware, or a virtual function instantiated on an application platform operating on general-purpose hardware.

The communication device 1 is, for example, a base station that supports a communication system defined in Third Generation Partnership Project (3GPP) such as Long Term Evolution (LTE) and New Radio (NR). The base station is connected, for example, to a terminal device and a core network that support LTE and NR. The base station and the core network are connected via an Si interface or an NG interface and base stations are connected via an X2 interface or an Xn interface without limitation thereto.

A base station employing NR is divided, for example, into a centralized unit (CU), a distributed unit (DU), and a radio unit (RU). Among these units, the CU hosts, for example, a packet data convergence protocol (PDCP) layer. The DU hosts, for example, a radio link control (RLC) layer, a media access control (MAC) layer, and an upper part (high PHY layer) among physical (PHY) layers. The RU hosts, for example, a lower part (low PHY layer) among physical (PHY) layers. The DU and the RU are connected to each other via an interface referred to as a fronthaul. The CU and the DU are also connected to each other via an interface.

The communication device 1 includes a communication device 2 and a communication device 3. The communication device 2 according to the present example embodiment plays a role as a second communication device, and the communication device 3 plays a role as a first communication device. As described above, for example, the communication device 1 is a base station, and therefore the communication device 2 and the communication device 3 indicate that therein, all or some of functions of the base station are disposed in a distributed manner. The communication device 1 may include another communication device other than the communication device 2 and the communication device 3. In other words, the base station functions may be disposed, in a distributed manner, in a plurality of communication devices including the communication device 2 and the communication device 3.

The communication device 2, for example, may be an O-DU (or a DU) defined by O-RAN Alliance, and the communication device 3 may be an O-RU (or an RU) defined by O-RAN Alliance. The communication device 2 and the communication device 3 are connected via an interface 4. The interface 4 may be an open fronthaul defined by O-RAN Alliance. Of course, the communication device 2, the communication device 3, and the interface 4 are not limited to these units and may be a device or an interface defined by 3GPP. For example, the communication device 2 may be a DU, the communication device 3 may be an RU, and the interface 4 may be a fronthaul. The another communication device included in the communication device 1 other than the communication device 2 and the communication device 3 may be a CU. An interface connecting the CU and the communication device 2 may be an F1 interface.

In FIG. 2, the communication device 2 includes a reception unit 21 and a transmission unit 22.

The reception unit 21 is configured in such a way as to receive downlink data from a high-order device. The high-order device may be a CU. The transmission unit 22 is configured in such a way as to transmit, to the communication device 3, downlink data and information necessary for beam forming.

In FIG. 3, the communication device 3 includes a reception unit 31, a parameter calculation unit 32, and a monitoring packet generation unit 33.

The reception unit 31 is configured in such a way as to receive, from the communication device 2, downlink data and information necessary for beam forming. Herein, the information necessary for beam forming is repeatedly transmitted from the communication device 2 in a time interval of, for example, 0.5 milliseconds or 20 milliseconds.

The parameter calculation unit 32 is configured in such a way as to calculate, based on information necessary for beam forming received by the reception unit 31, a beam forming parameter for forming a beam used when a downlink signal is transmitted to a terminal device. The parameter calculation unit 32 calculates a beam forming parameter each time information necessary for beam forming is received. The beam forming parameter may include, for example, a beamforming weight to be described later.

The monitoring packet generation unit 33 is configured in such a way as to generate a monitoring packet including a beam forming parameter calculated by the parameter calculation unit 32 and transmit the generated monitoring parameter to the interface 4. The monitoring packet generation unit 33 generates, each time a beam forming parameter is calculated, a monitoring packet including the beam forming parameter.

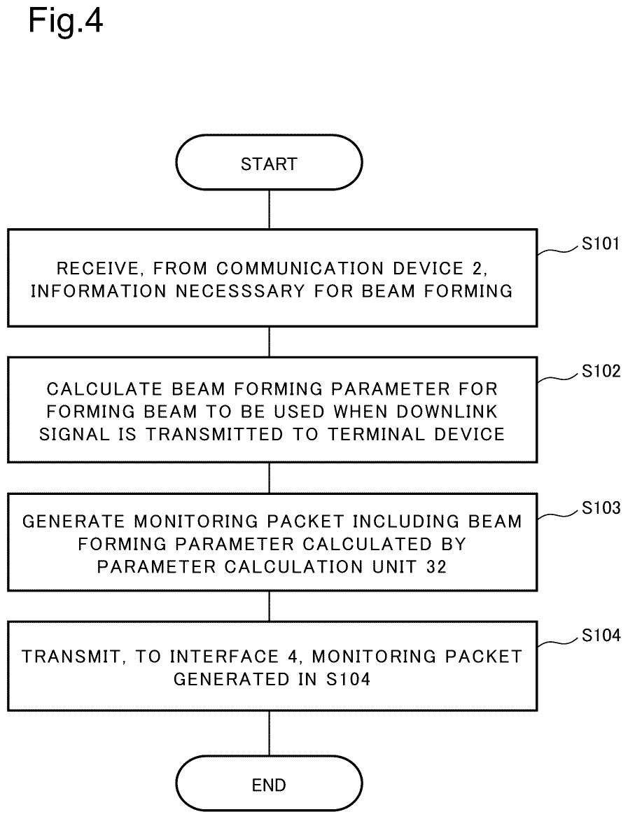

Subsequently, by using FIG. 4, an operation example of the communication device 3 according to the first example embodiment is described. FIG. 4 is a sequence diagram illustrating an operation example of the communication device 3 according to the first example embodiment.

In the communication device 3, the reception unit 31 receives, from the communication device 2, information necessary for beam forming (S101).

The parameter calculation unit 32 of the communication device 3 calculates a beam forming parameter for forming a beam used when a downlink signal is transmitted to a terminal device (S102).

The monitoring packet generation unit 33 of the communication device 3 generates a monitoring packet including the beam forming parameter calculated by the parameter calculation unit 32 (S103).

The monitoring packet generation unit 33 of the communication device 3 transmits the monitoring packet generated in S103 to the interface 4 (S104).

As described above, the communication device 3 can transmit information representing a beam pattern to the interface 4. Therefore, the communication device 3 can easily achieve beam pattern monitoring.

### Second Example Embodiment

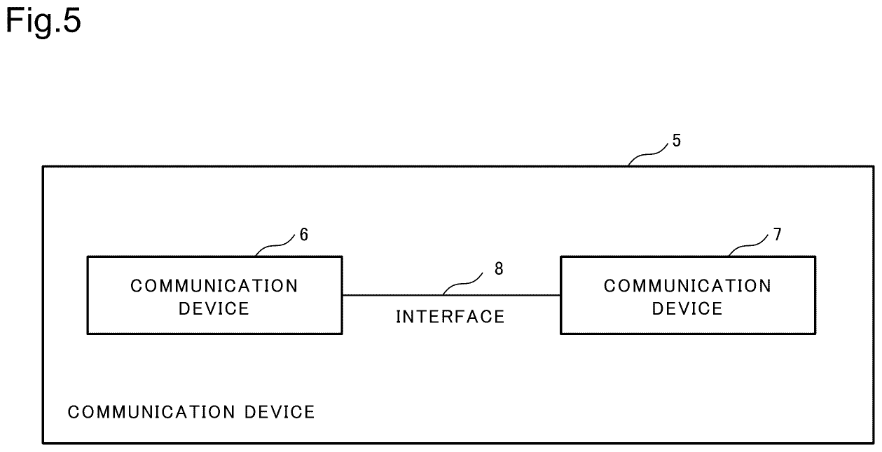

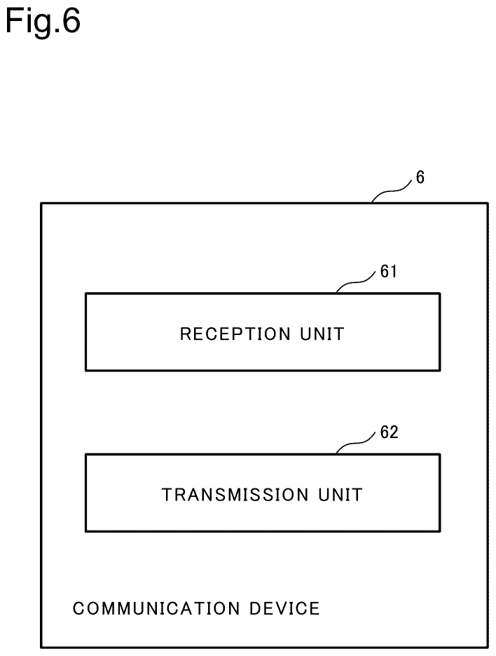

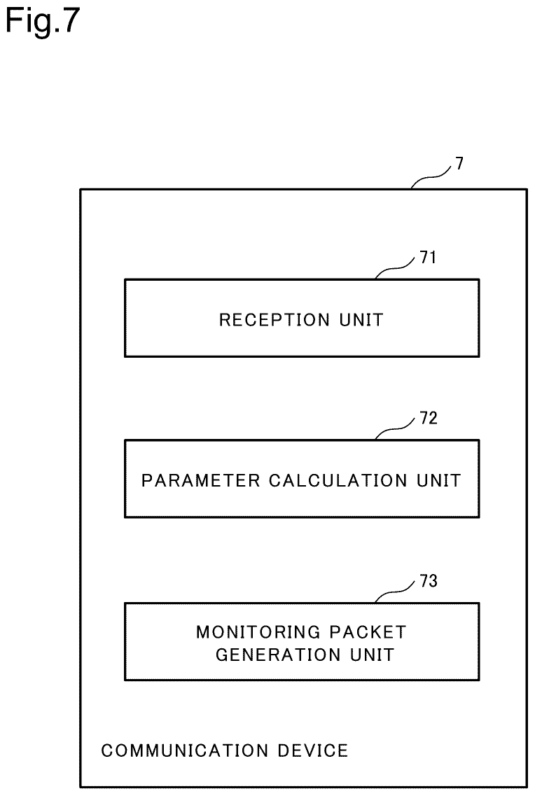

FIG. 5 illustrates a configuration example of a communication device 5 according to the present example embodiment, FIG. 6 illustrates a configuration example of a communication device 6 according to the present example embodiment, and FIG. 7 illustrates a configuration example of a communication device 7 according to the present example embodiment. The communication device 5 is relevant to the communication device 1 according to the first example embodiment, the communication device 6 is relevant to the communication device 2 according to the first example embodiment, and the communication device 7 is relevant to the communication device 3 according to the first example embodiment. An interface 8 is relevant to the interface 4 according to the first example embodiment.

The communication device 5 may be, for example, a base station that supports a communication system defined in Third Generation Partnership Project (3GPP) such as Long Term Evolution (LTE) and New Radio (NR).

The communication device 5 includes the communication device 6 and the communication device 7. As described above, the communication device 5 is, for example, a base station, and therefore the communication device 6 and the communication device 7 indicate that therein, all or some of functions of the base station are disposed in a distributed manner. The communication device 5 may include another communication device other than the communication device 6 and the communication device 7. In other words, the base station functions may be disposed, in a distributed manner, in a plurality of communication devices including the communication device 6 and the communication device 7.

The communication device 6 may be, for example, an O-DU (or a DU) defined by O-RAN Alliance, and the communication device 7 may be, for example, an O-RU (or an RU) defined by O-RAN Alliance. The communication device 6 and the communication device 7 are connected via the interface 8. The interface 8 may be an open fronthaul defined by O-RAN Alliance. Of course, the communication device 6, the communication device 7, and the interface 8 are not limited to these units and may be a device or an interface defined by 3GPP. For example, the communication device 6 may be a DU, the communication device 7 may be an RU, and the interface 8 may be a fronthaul. The another communication device included in the communication device 5 other than the communication device 6 and the communication device 7 may be a CU.

In FIG. 6, the communication device 6 includes a reception unit 61 and a transmission unit 62. The reception unit 61 and the transmission unit 62 each are relevant to the reception unit 21 and the transmission unit 22 according to the first example embodiment.

The reception unit 61 is configured in such a way as to receive downlink data from a high-order device. The high-order device may be a CU. The transmission unit 62 is configured in such a way as to transmit, to the communication device 7, downlink data and information necessary for beam forming.

In FIG. 7, the communication device 7 includes a reception unit 71, a parameter calculation unit 72, and a monitoring packet generation unit 73. The reception unit 71, the parameter calculation unit 72, and the monitoring packet generation unit 73 each are relevant to the reception unit 31, the parameter calculation unit 32, and the monitoring packet generation unit 33 according to the first example embodiment.

The reception unit 71 is configured in such a way as to receive, from the communication device 6, downlink data and information necessary for beam forming. Herein, the information necessary for beam forming is repeatedly transmitted from the communication device 6 in a time interval of, for example, 0.5 milliseconds or 20 milliseconds.

The parameter calculation unit 72 is configured in such a way as to calculate, based on information necessary for beam forming received by the reception unit 71, a beam forming parameter for forming a beam used when a downlink signal is transmitted to a terminal device. The parameter calculation unit 72 calculates a beam forming parameter each time information necessary for beam forming is received. The beam forming parameter may include, for example, a beamforming weight to be described later.

The monitoring packet generation unit 73 is configured in such a way as to generate, each time the parameter calculation unit 72 calculates a beam forming parameter, a monitoring packet including the beam forming parameter. The monitoring packet generation unit 73 is configured in such a way as to select at least one specific monitoring packet from among all generated monitoring packets and transmit the selected monitoring packet to the interface 8. Of course, the monitoring packet generation unit 73 may recognize all generated monitoring packets as a “monitoring packet to be transmitted”.

Herein, selection of a monitoring packet based on the monitoring packet generation unit 73 is described. The monitoring packet generation unit 73 may not necessarily transmit all monitoring packets generated by the monitoring packet generation unit 73 but may transmit a specific monitoring packet to the interface 8. In other words, the monitoring packet generation unit 73 may select some monitoring packets from among all monitoring packets generated by the monitoring packet generation unit 73 as a “monitoring packet to be transmitted”. Then, the monitoring packet generation unit 73 may transmit the monitoring packets to be transmitted to the interface 8.

More specifically, by using the parameter calculation unit 72, at least one beam forming parameter is calculated per unit frequency, per unit time, or for each combination of frequency and time.

The monitoring packet generation unit 73 may select, as a monitoring packet to be transmitted, from among all monitoring packets including the beam forming parameter, a monitoring packet including a beam forming parameter of a “partial frequency band used by a beam formed for communication with a terminal device”. The “partial frequency band used by a beam formed for communication with a terminal device”, for example, may not necessarily be an entire frequency band used by a beam generated by the communication device 7 but may be at least one of a plurality of partial frequency bands in which the entire frequency band is divided. The partial frequency band may be, for example, a bandwidth part (BWP). In other words, the monitoring packet generation unit 73 may select, when, for example, a frequency band used in the communication device 7 is divided into a plurality of partial bands, as a monitoring packet to be transmitted, a monitoring packet including a beam forming parameter of a beam configuring at least one partial band among the plurality of partial bands. Even when the communication device 7 does not employ a partial band, the configuration is applicable. When, for example, an entire frequency band (system band) used by the communication device 7 is 20 MHz, the monitoring packet generation unit 73 may select, from among all monitoring packets including a beam forming parameter calculated for the entire frequency band (system band), as a monitoring packet to be transmitted, a monitoring packet including a beam forming parameter for a frequency band of a certain 1 MHz portion. The monitoring packet generation unit 73 may select, in an entire time in which a sequence of data transmissions is performed, as a monitoring packet to be transmitted, a monitoring packet including a beam forming parameter for forming a beam used in a specific time.

The monitoring packet generation unit 73 may divide one monitoring packet to be transmitted into a plurality of division packets (a plurality of data units) and transmit, to the interface 8, the plurality of division packets at least one by one. As a unit of division, one slot at a time, one resource block at a time, and the like are cited without limitation.

Of course, the above-described operation may be performed independently or may be performed based on an appropriate combination. Thereby, the communication device 7 can transmit, to the interface 8, a monitoring packet while pressure on a band of the interface 8 is avoided.

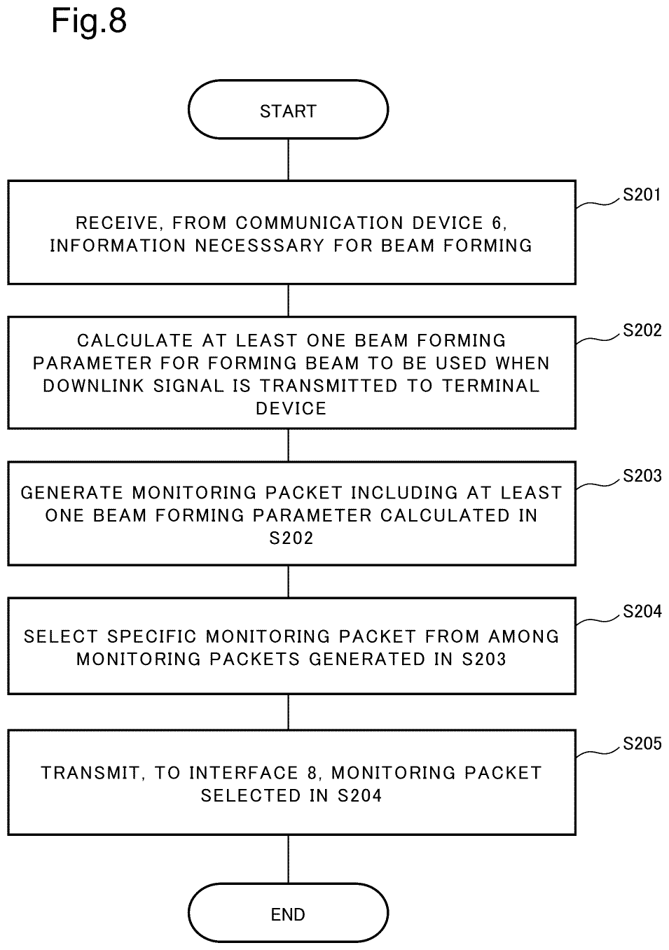

Subsequently, by using FIG. 8, an operation example of the communication device 7 according to the second example embodiment is described. FIG. 8 is a sequence diagram illustrating an operation example of the communication device 7 according to the second example embodiment.

The reception unit 71 of the communication device 7 receives, from the communication device 6, information necessary for beam forming (S201).

The parameter calculation unit 72 of the communication device 7 calculates at least one beam forming parameter for forming a beam used when a downlink signal is transmitted to a terminal device (S202).

The monitoring packet generation unit 73 of the communication device 7 generates a monitoring packet including the at least one beam forming parameter calculated in S202 (S203).

The monitoring packet generation unit 73 of the communication device 7 selects, from among the monitoring packets generated in S203, a specific monitoring packet (S204).

The monitoring packet generation unit 73 of the communication device 7 transmits, to the interface 8, the monitoring packet selected in S204 (S205).

As described above, the communication device 7 selects a monitoring packet including a beam forming parameter and can transmit, to the interface 8, the selected monitoring packet. Therefore, the communication device 7 can easily achieve beam pattern monitoring while pressure on a band of the interface 8 is avoided.

In the above description, description has been made, without limitation, assuming that from among all generated monitoring packets, a monitoring packet to be transmitted is selected. The monitoring packet generation unit 73, for example, may not necessarily generate a packet not to be transmitted but may generate only a monitoring packet to be transmitted.

### Third Example Embodiment

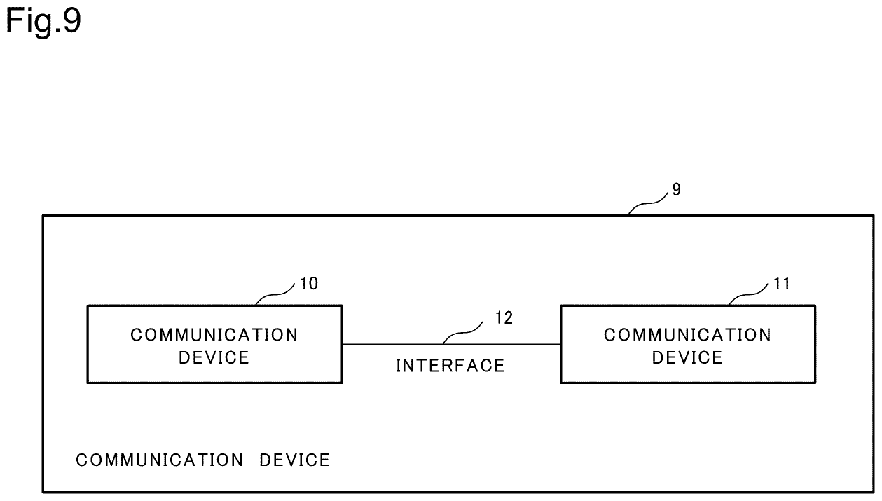

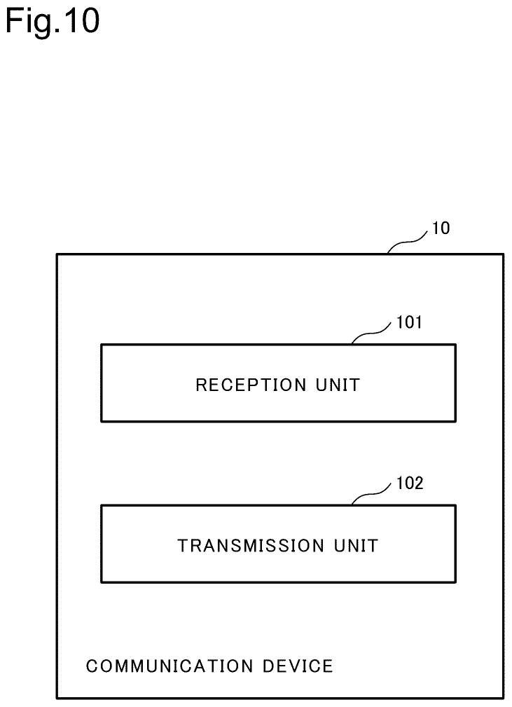

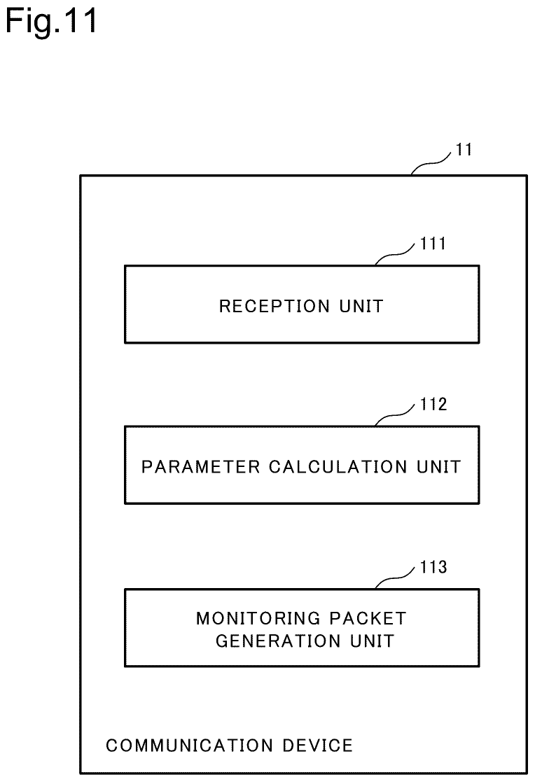

FIG. 9 illustrates a configuration example of a communication device 9 according to the present example embodiment, FIG. 10 illustrates a configuration example of a communication device 10 according to the present example embodiment, and FIG. 11 illustrates a configuration example of a communication device 11 according to the present example embodiment. The communication device 9 is relevant to the communication device 1 according to the first example embodiment, the communication device 10 is relevant to the communication device 2 according to the first example embodiment, and the communication device 11 is relevant to the communication device 3 according to the first example embodiment. An interface 12 is relevant to the interface 4 according to the first example embodiment.

The communication device 9 may be, for example, a base station that supports a communication system defined in Third Generation Partnership Project (3GPP) such as Long Term Evolution (LTE) and New Radio (NR).

The communication device 9 includes a communication device 10 and a communication device 11. As described above, the communication device 9 is a base station, and therefore the communication device 10 and the communication device 11 indicate that therein, all or some of functions of the base station are disposed in a distributed manner. The communication device 9 may include another communication device other than the communication device 10 and the communication device 11. In other words, base station functions may be disposed, in a distributed manner, in a plurality of communication devices including the communication device 10 and the communication device 11.

The communication device 10 may be, for example, an O-DU (or a DU) defined by O-RAN Alliance, and the communication device 11 may be, for example, an O-RU (or an RU) defined by O-RAN Alliance. The communication device 10 and the communication device 11 are connected via the interface 12. The interface 12 may be an open fronthaul defined by O-RAN Alliance. Of course, the communication device 10, the communication device 11, and the interface 12 are not limited to these units and may be a device or an interface defined by 3GPP. For example, the communication device 10 may be a DU, the communication device 11 may be an RU, and the interface 12 may be a fronthaul. The another communication device included in the communication device 9 other than the communication device 10 and the communication device 11 may be a CU.

In FIG. 10, the communication device 10 includes a reception unit 101 and a transmission unit 102. The reception unit 101 and the transmission unit 102 each are relevant to the reception unit 21 and the transmission unit 22 according to the first example embodiment.

The reception unit 101 of the communication device 10 is configured in such a way as to receive downlink data from a high-order device. The high-order device may be a CU. The transmission unit 102 is configured in such a way as to transmit, to the communication device 11, downlink data and information necessary for beam forming.

In FIG. 11, the communication device 11 includes a reception unit 111, a parameter calculation unit 112, and a monitoring packet generation unit 113. The reception unit 111, the parameter calculation unit 112, and the monitoring packet generation unit 113 each are relevant to the reception unit 31, the parameter calculation unit 32, and the monitoring packet generation unit 33 according to the first example embodiment. The transmission unit 102 is configured in such a way as to request the communication device 11 to transmit a monitoring packet to the interface 12 or the communication device 10. A request is issued in such a way that a monitoring packet is transmitted from the communication device 10 to the interface 12 or the communication device 10, and thereby beam pattern monitoring can be achieved on demand.

The transmission unit 102 may request, by indicating a selection method of a monitoring packet, the communication device 11 to transmit a monitoring packet to the interface 12. More specifically, the transmission unit 102 may request the communication device 11 to transmit, to the interface 12, a monitoring packet including a beam forming parameter of a beam using a specific time and frequency band. The specific time is a partial time specified by the transmission unit 102 in an entire time in which a beam for communication with a terminal device is formed and a sequence of data transmissions is performed. The specific frequency band is a partial frequency band specified by the transmission unit 102 in an entire frequency band used by a beam formed for communication with a terminal device.

The reception unit 111 of the communication device 11 is configured in such a way as to receive a request for transmitting downlink data, information necessary for beam forming, and a monitoring packet from the communication device 10 to the interface 12 or the communication device 10. The parameter calculation unit 112 is configured in such a way as to calculate a beam forming parameter for forming a beam used when a downlink signal is transmitted to a terminal device based on information necessary for beam forming received by the reception unit 111. The parameter calculation unit 112 calculates a beam forming parameter each time information necessary for beam forming is received. The beam forming parameter may include, for example, a beamforming weight to be described later.

The monitoring packet generation unit 113 is configured in such a way as to generate, according to a request from the communication unit 10 received by the reception unit 111, a monitoring packet including a beam forming parameter calculated by the parameter calculation unit 112 and transmit the generated monitoring packet to the interface 12 or the communication device 10. Herein, at least either of information necessary for beam forming and a request for transmitting a monitoring packet to the interface 12 or the communication device 10 is repeatedly transmitted from the communication device 10 in a time interval of, for example, 0.5 milliseconds or 20 milliseconds.

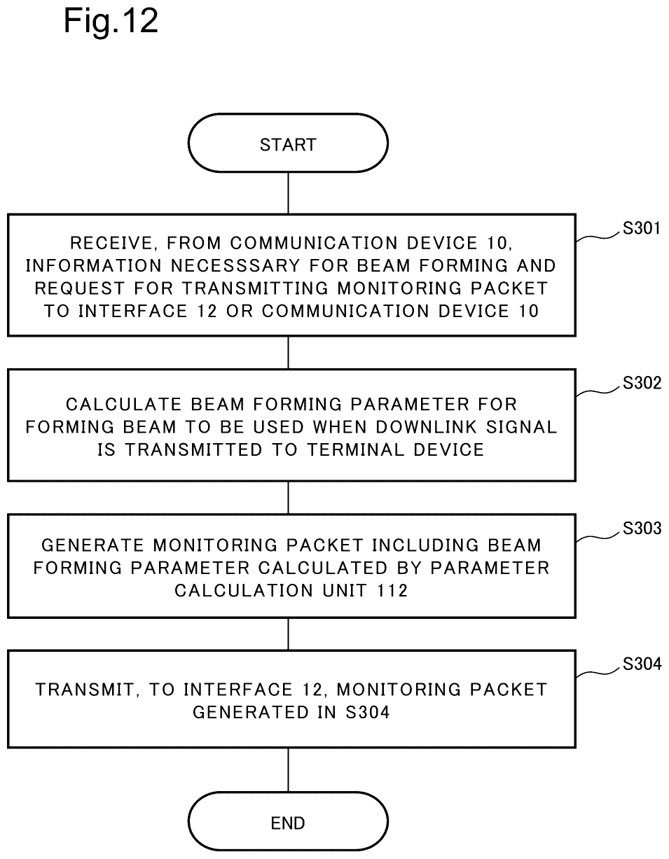

Subsequently, by using FIG. 12, an operation example of the communication device 10 and the communication device 11 according to the third example embodiment is described. FIG. 12 is a sequence diagram illustrating an operation example of the communication device 10 and the communication device 11 according to the third example embodiment.

The reception unit 111 of the communication device 11 receives, from the communication device 10, information necessary for beam forming and a request for transmitting a monitoring packet to the interface 12 or the communication device 10 (S301).

The parameter calculation unit 112 of the communication device 11 calculates a beam forming parameter for forming a beam used when a downlink signal is transmitted to a terminal device (S302).

The monitoring packet generation unit 113 of the communication device 11 generates a monitoring packet including the beam forming parameter calculated by the parameter calculation unit 112 (S303).

The monitoring packet generation unit 113 of the communication device 11 transmits, to the interface 12, the monitoring packet generated in S303 (S304).

As described above, the communication device 11 can transmit, according to a request from the communication device 10, information representing a beam pattern to the interface 12 or the communication device 10. Therefore, the communication device 11 can achieve beam pattern monitoring on demand.

### Fourth Example Embodiment

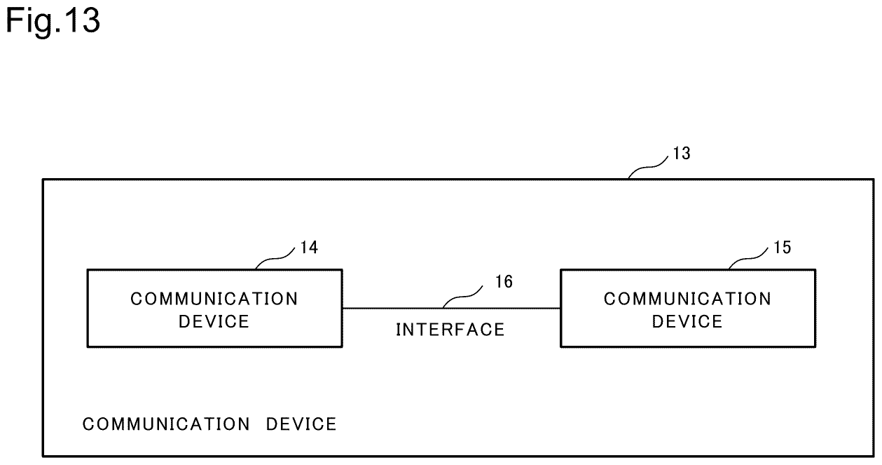

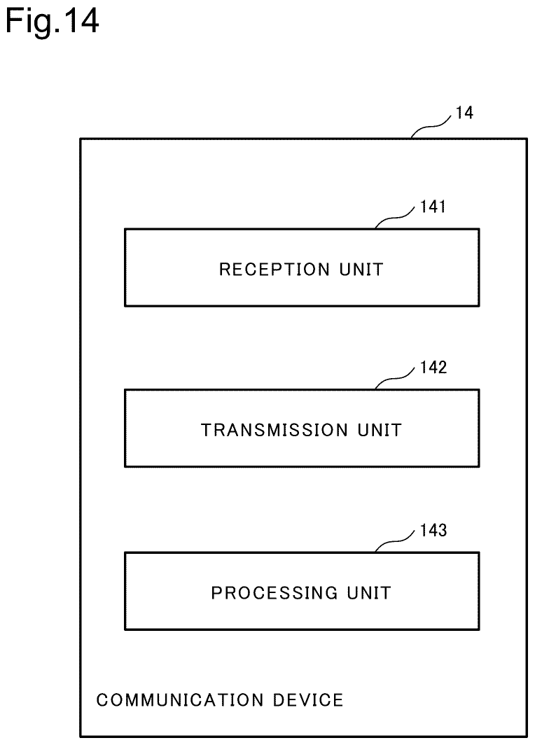

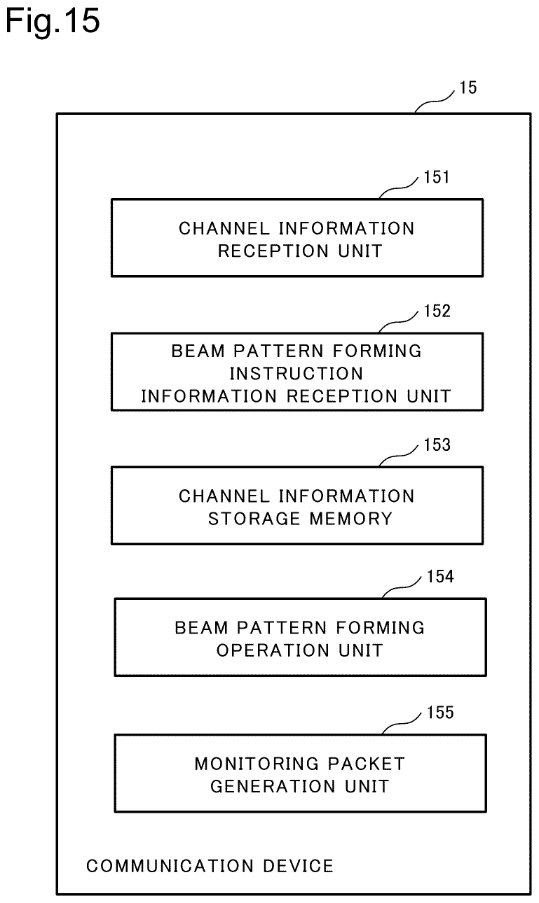

FIG. 13 illustrates a configuration example of a communication device 13 according to the present example embodiment, FIG. 14 illustrates a configuration example of a communication device 14 according to the present example embodiment, and FIG. 15 illustrates a configuration example of a communication device 15 according to the present example embodiment. The communication device 13 is relevant to the communication device 1 according to the first example embodiment, the communication device 14 is relevant to the communication device 2 according to the first example embodiment, and the communication device 15 is relevant to the communication device 3 according to the first example embodiment. An interface 16 is relevant to the interface 4 according to the first example embodiment.

The communication device 13 may be, for example, a base station that supports a communication system defined in Third Generation Partnership Project (3GPP) such as Long Term Evolution (LTE) and New Radio (NR).

The communication device 13 includes the communication device 14 and the communication device 15. As described above, the communication device 13 is a base station, and therefore the communication device 14 and the communication device 15 indicate that therein, all or some of functions of the base station are disposed in a distributed manner. The communication device 13 may include another communication device other than the communication device 14 and the communication device 15. In other words, base station functions may be disposed, in a distributed manner, in a plurality of communication devices including the communication device 14 and the communication device 15.

The communication device 14 may be, for example, an O-DU (or a DU) defined by O-RAN Alliance, and the communication device 15 may be, for example, an O-RU (or an RU) defined by O-RAN Alliance. The communication device 14 and the communication device 15 are connected via the interface 16. The interface 16 may be an open fronthaul defined by O-RAN Alliance. Of course, the communication device 14, the communication device 15, and the interface 16 are not limited to these units and may be a device or an interface defined by 3GPP. For example, the communication device 14 may be a DU, the communication device 15 may be an RU, and the interface 16 may be a fronthaul. The another communication device included in the communication device 13 other than the communication device 14 and the communication device 15 may be a CU.

In FIG. 14, the communication device 14 includes a reception unit 141, a transmission unit 142, and a processing unit 143. The reception unit 141 is relevant to the reception unit 21 according to the first example embodiment, and the transmission unit 142 is relevant to the transmission unit 22 according to the first example embodiment.

The reception unit 141 of the communication device 14 is configured in such a way as to receive, from a high-order device, downlink data (a user plane (U-plane)) and a control plane (C-plane).

The high-order device may be a CU. The reception unit 141 may be configured in such a way as to receive a monitoring packet, to be described later, transmitted onto the interface 16 by the communication device 15.

The transmission unit 142 is configured in such a way as to transmit, to the communication device 15, downlink data and “information necessary for beam forming”. The “information necessary for beam forming” is, for example, information of a C-plane defined by O-RAN Alliance and includes information included in a C-plane signal of Section Type 5 and a C-plane signal of Section Type 6. Hereinafter, the C-plane signal of Section Type 5 and the C-plane signal of Section Type 6 each may be simply referred to as a section type 5 and a section type 6. The C-plane signal may be also referred to as a packet signal of a C-plane.

Herein, information of a section type 6 and a section type 5 is described. The section type 6 includes channel information. The channel information is information representing a state of each of a plurality of propagation paths between a terminal device and the communication device 15. Each propagation path is relevant to each pair of an antenna of the terminal device and an antenna of the communication device 15. The channel information is frequently represented by a matrix H and is referred also as a channel matrix. When, for example, the communication device 15 including 64 antennas preforms beam forming for eight terminal devices each including two antennas, channel information is represented as the following Expression (1).

$$\begin{matrix}[ Math . 1 ] & \\ [ \begin{matrix}{H}_{1} \\ {H}_{2} \\ … \\ … \\ {H}_{8}\end{matrix} ] = [ \begin{matrix}[ \begin{matrix}{h}_{1 , 1 , 1} & {h}_{1 , 1 , 2} & {h}_{1 , 1 , 3} & … & {h}_{1 , 1 , 63} & {h}_{1 , 1 , 64} \\ {h}_{1 , 2 , 1} & {h}_{1 , 2 , 2} & {h}_{1 , 2 , 3} & … & {h}_{1 , 2 , 63} & {h}_{1 , 2 , 64}\end{matrix} ] \\ [ \begin{matrix}{h}_{2 , 1 , 1} & {h}_{2 , 1 , 2} & {h}_{2 , 1 , 3} & … & {h}_{2 , 1 , 63} & {h}_{2 , 1 , 64} \\ {h}_{2 , 2 , 1} & {h}_{2 , 2 , 2} & {h}_{2 , 2 , 3} & … & {h}_{2 , 2 , 63} & {h}_{2 , 2 , 64}\end{matrix} ] \\ … \\ … \\ [ \begin{matrix}{h}_{8 , 1 , 1} \\ {h}_{8 , 2 , 1}\end{matrix} \begin{matrix}{h}_{8 , 1 , 2} & {h}_{8 , 1 , 3} & … & {h}_{8 , 1 , 63} & {h}_{8 , 1 , 64} \\ {h}_{8 , 2 , 2} & {h}_{8 , 2 , 3} & … & {h}_{8 , 2 , 63} & {h}_{8 , 2 , 64}\end{matrix} ]\end{matrix} ] & ( 1 )\end{matrix}$$

In Expression (1), h_{UE #,UEAnt #,RUAnt #} represents that a state of a transmission path between an antenna of each terminal device and an antenna of a base station, UE # is an identifier for discriminating a terminal device, UEAnt # is an identifier for discriminating an antenna included in a terminal device, and RUAnt # is an identifier for discriminating an antenna included in a base station. Formats of packets of section types 5 and 6 are defied by O-RAN Alliance.

Subsequently, a section type 5 is described. The section type 5 includes information instructing which user to select for forming a beam, in the channel information described in Expression (1). According to the section type 5, a format for specifying a target user number (UE ID/ueId [14:8]), a resource block (RB) number on a frequency axis, and the like is indicated.

The processing unit 143 is configured in such a way as to analyze a monitoring packet received by the reception unit 141. The monitoring packet includes a beam forming parameter to be described later, and the beam forming parameter includes, for example, a beamforming weight to be described later. When, for example, a beamforming weight is analyzed, the processing unit 143 may analyze the beamforming weight, draw a beam pattern, and output the drawn beam pattern to an external device.

In FIG. 15, the communication device 15 includes a channel information reception unit 151, a beam pattern forming instruction information reception unit 152, a channel information storage memory 153, a beam pattern forming operation unit 154, and a monitoring packet generation unit 155. The channel information reception unit 151 and the beam pattern forming instruction information reception unit 152 are relevant to the reception unit 31 according to the first example embodiment, and the beam pattern forming operation unit 154 is relevant to the parameter calculation unit 32 according to the first example embodiment. The monitoring packet generation unit 155 is relevant to the monitoring packet generation unit 33 according to the first example embodiment.

The channel information reception unit 151 of the communication device 15 is configured in such a way as to receive a section type 6, extracts channel information from the section type 6, and stores the extracted channel information in the channel information storage memory 153. The section type 6 is received, for example, every 0.5 milliseconds or 20 milliseconds.

The beam pattern forming instruction information reception unit 152 is configured in such a way as to receive the section type 5. The section type 5 is received, for example, every 0.5 milliseconds. The beam pattern forming instruction information reception unit 152 is configured in such a way as to instruct, when receiving the section type 5, the channel information storage memory 153 to output, to the beam pattern forming operation unit 154, channel information of a terminal device and a location of an RB on a frequency axis specified by the section type 5 from among pieces of channel information stored in the channel information storage memory 153. The beam pattern forming instruction information reception unit 152 is configured in such a way as to instruct the beam pattern forming operation unit 154 to calculate a beamforming weight.

The channel information storage memory 153 is configured in such a way as to store channel information of each terminal device included in the section type 6.

The beam pattern forming operation unit 154 is configured in such a way as to receive an instruction from the beam pattern forming instruction information reception unit 152, receive channel information specified by the channel information storage memory 153, and calculate a beamforming weight. An algorithm used for calculating a beamforming weight by the beam pattern forming operation unit 154 includes, but not limited to, Zero-Forcing (ZF), Minimum Mean Squared Error (MMSE), and the like.

Herein, a beamforming weight is described. The beamforming weight is information calculated, in order to form a beam for a user specified by a section type 5, based on appropriate channel information in a list of all communication terminals having been already received in the section type 6. The beamforming weight may be calculated based on only a piece of channel information specified from among pieces of channel information with respect to communication terminals received in the section type 6. The beamforming weight is frequently represented by W. When a reception signal on a terminal device side is Y, channel information is H, a beam forming weight is W, a transmission signal is X, and noise on the terminal device side is N, generally, the following Expression (2) can be represented.

$$\begin{matrix}[ Math . 2 ] & \\ Y = HWX + N = {H ( {H}^{H} H )}^{- 1} {H}^{H} X + N = [ \begin{matrix}1 & … & 0 \\ ⋮ & ⋱ & ⋮ \\ 0 & … & 1\end{matrix} ] X + N & ( 2 )\end{matrix}$$

In this manner, based on channel information H, a beamforming weight W, and the like, a beam received by a terminal device is formed. Other than the above-described algorithm, there is an algorithm in which channel information is subjected to eigenvalue decomposition (EVD) and an eigenvalue decomposition result (EVD result) is handled as new channel information. When such an algorithm is used, the beam pattern forming operation unit 154 may cause channel information to be subjected to eigenvalue decomposition.

The beam pattern forming operation unit 154 may be referred to as an inverse matrix (mat. inv) accelerator, a mat. inv calculator, or a mat. inv calculation accelerator.

The monitoring packet generation unit 155 is configured in such a way as to collect, from function units of the communication device 15, various pieces of information and transmit the collected information to the interface 16. More specifically, the monitoring packet generation unit 155 is configured in such a way as to collect, from the channel information reception unit 151, the beam pattern forming instruction information reception unit 152, the channel information storage memory 153, and the beam pattern forming operation unit 154, information to be handled by each function unit and transmit the collected information to the interface 16. In other words, the monitoring packet generation unit 155 may output, based on a monitoring packet format, the collected information to the interface 16.

Information collected by the monitoring packet generation unit 155 and then transmitted to the interface 16, i.e., information transmitted based on a monitoring packet format includes, but not limited to, for example, a section type 5, a section type 6, channel information, an inverse matrix of channel information, a beamforming weight, an EVD result, and the like. For example, various types of values acquired when the beam pattern forming operation unit 154 calculates a beamforming weight are applicable.

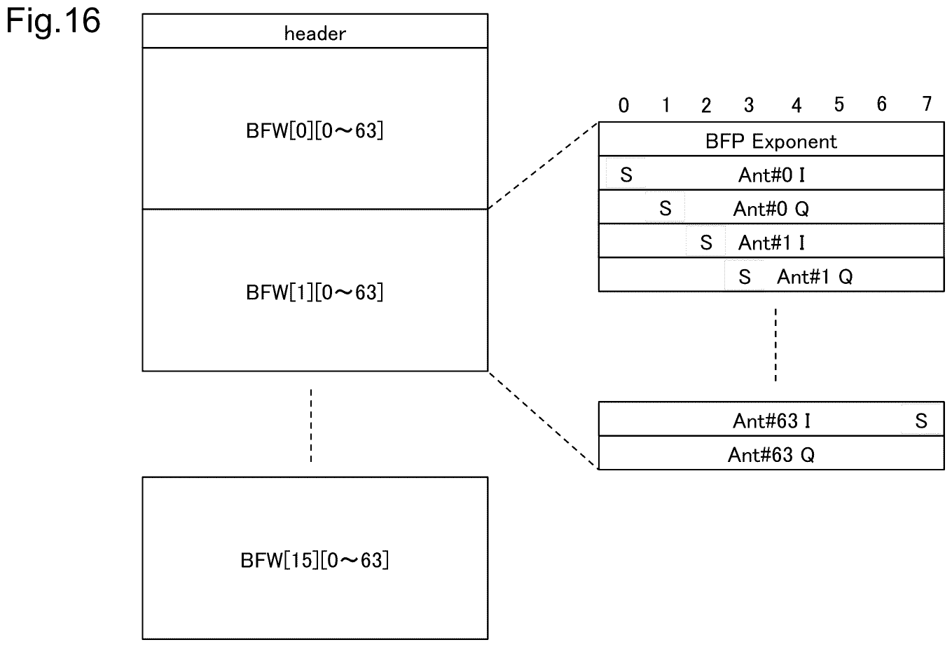

FIG. 16 illustrates an example of a monitoring packet to be transmitted to the interface 16 by the monitoring packet generation unit 155, specifically, an example in which a monitoring packet including a beamforming weight is transmitted to the interface 16. Generally, when eight terminal devices each include two antennas, 16 beamforming weights are required in total. When a base station that communicates with these terminal devices by using beam forming includes 64 array antennas, a beamforming weight is represented by a two-dimensional matrix using 16×64=1024 complex numbers and is a beamforming weight per frequency resolution. The resolution is not limited to each frequency, and the beamforming weight may be a beamforming weight per subcarrier, per RB, or per plurality of RBs without limitation.

FIG. 16 is an example of a monitoring packet representing the two-dimensional matrix. A header may be freely set, for example, by a communication carrier of a communication system in which the communication device 15 is incorporated. When, for example, the present information is not required in the communication device 14, a header may be set in such a way that the present monitoring packet is discarded as an abnormal packet in the communication device 14. When a monitoring device that analyzes a monitoring packet and confirms a shape of a beam is installed on the interface 16 or the processing unit 143 analyzes a monitoring packet and confirms a shape of a beam, the monitoring packet generation unit 155 may set a header of a monitoring packet as a shape suitable for the monitoring device or the processing unit 143.

When a beamforming weight in a certain one-unit resolution is represented on an I/Q plane, the beamforming weight is configured based on 1024 pieces of IQ data. These pieces of IQ data may be applied with any of various types of bit compression methods, and in the example of FIG. 16, a monitoring packet is configured by using 9-bit block floating point employed by O-RAN Alliance. In the example of FIG. 16, one exponential part (BFP exponent) is defined per 64 antennas, and IQ data are represented by 9 bits. Therefore, in representation based on 8 bits, a sign bit (S) is sequentially shifted. The pieces of IQ data may be transmitted as a payload part of Ethernet.

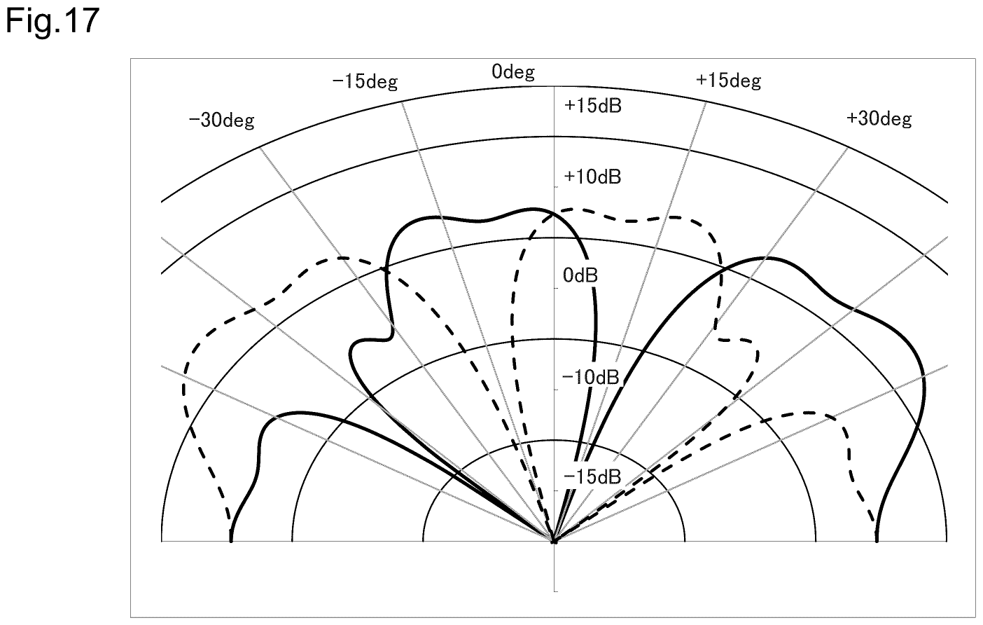

FIG. 17 illustrates one example of a beam pattern, and two beams are orthogonal to each other in a ±15 degree-direction and a ±46-degree direction. In this manner, a monitoring packet transmitted onto the interface 16 by the communication device 15 according to the present example embodiment is analyzed by a monitoring device on the interface 16 or the processing unit 143 of the communication device 14, and thereby a beam pattern can be confirmed without actual measurement of the beam pattern.

The monitoring packet generation unit 155 may collect, each time information handled by each of function units is received, calculated, or output to another function unit, the information, generate a monitoring packet including the information, and immediately transmit the monitoring packet to the interface 16. More specifically, the monitoring packet generation unit 155 may immediately collect, each time, for example, the channel information reception unit 151 receives a section type 6, the section type 6, generate a monitoring packet including the section type 6, and transmit the monitoring packet to the interface 16. The monitoring packet generation unit 155 may immediately collect, each time the beam pattern forming instruction information reception unit 152 receives a section type 5, the section type 5, generates a monitoring packet including the section type 5, and transmit the monitoring packet to the interface 16. Similarly, the monitoring packet generation unit 155 may collect, each time the channel information storage memory 153 receives channel information from the channel information reception unit 151 and stores the channel information, the channel information, generate a monitoring packet including the channel information, and transmit the monitoring packet to the interface 16. The monitoring packet generation unit 155 may collect, each time the beam pattern forming operation unit 154 calculates a beamforming weight and outputs the calculated beamforming weight, the beamforming weight, generate a monitoring packet including the beamforming weight, and immediately transmit the beamforming weight to the interface 16. The monitoring packet generation unit 155 immediately collects various types of information, generates a monitoring packet including the information, and outputs the monitoring packet to the interface 16, and thereby various types of information can be confirmed more rapidly without a time interval.

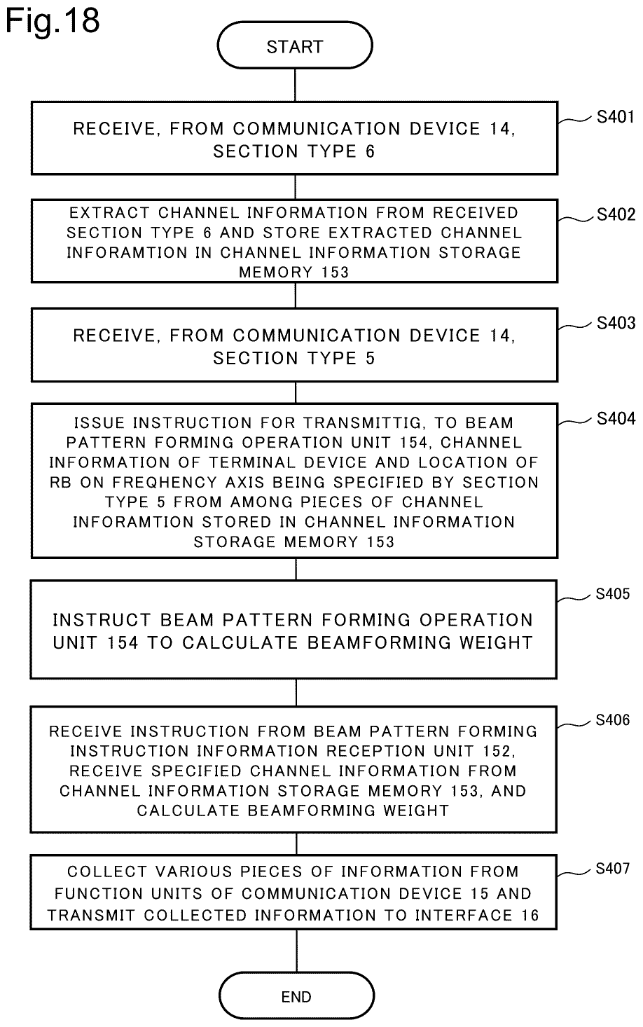

Subsequently, by using FIG. 18, an operation example of the communication device 15 according to the fourth example embodiment is described. FIG. 18 is a sequence diagram illustrating an operation example of the communication device 15 according to the fourth example embodiment.

The channel information reception unit 151 of the communication device 15 receives, from the communication device 14, a section type 6 (S401).

The channel information reception unit 151 of the communication device 15 extracts channel information from the received section type 6 and stores the channel information in the channel information storage memory 153 (S402).

The beam pattern forming instruction information reception unit 152 of the communication device 15 receives, from the communication device 14, a section type 5 (S403).

The beam pattern forming instruction information reception unit 152 of the communication device 15 issues an instruction in such a way as to transmit, to the beam pattern formation operation unit 154, channel information of a terminal device and a location of an RB on a frequency axis specified by the section type 5 from among pieces of channel information stored in the channel information storage memory 153 (S404).

The beam pattern forming instruction information reception unit 152 of the communication device 15 instructs the beam pattern forming operation unit 154 to calculate a beamforming weight (S405).

The beam pattern forming operation unit 154 of the communication device 15 receives the instruction from the beam pattern forming instruction information reception unit 152, receives specified channel information from the channel information storage memory 153, and calculates a beamforming weight (S406).

The monitoring packet generation unit 155 collects various pieces of information from function units of the communication device 15 and transmits the information to the interface 16 (S407).

As described above, the communication device 15 can collect various pieces of information including a beamforming weight handled by function units configuring the communication device 15 and transmit the information to the interface 16. Therefore, the communication device 15 can confirm various pieces of information without actual measurement of the information.

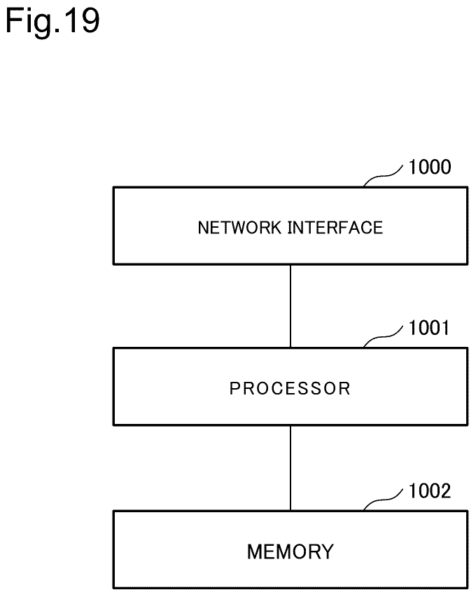

### Other Example Embodiments

<1> According to the first example embodiment to the fourth example embodiment, description has been made, assuming that a monitoring packet is processed by the communication devices 2, 6, 10, and 14 without limitation. A monitoring packet may be processed, for example, by a processing unit included in a device different from the communication devices 2, 6, 10, and 14, the device being connected to an interface.

<2> The communication devices 1, 2, 3, 5, 6, 7, 9, 10, 11, 13, 14, and 15 (hereinafter, referred to as the communication device 1 and the like) may include the following hardware configuration. FIG. 19 is a block diagram illustrating a hardware configuration of a computer (information processing device) capable of achieving the communication device of each example embodiment.

Referring to FIG. 19, the communication device 1 and the like include a network interface 1000, a processor 1001, and a memory 1002. The network interface 1000 is used for communicating with another radio communication device including a plurality of communication terminals. The network interface 1000 may include, for example, a network interface card (NIC) conforming to IEEE 802.11 series, IEEE 802.3 series, or the like.

The processor 1001 reads, from the memory 1002, software (a computer program), executes the software, and thereby executes processing of the communication device 1 and the like described by using the flowcharts and the sequence diagrams according to the above-described example embodiments. The processor 1001 may be, for example, a microprocessor, a micro processing unit (MPU), or a central processing unit (CPU). The processor 1001 may include a plurality of processors.

The memory 1002 is configured based on a combination of a volatile memory and a non-volatile memory. The memory 1002 may include a storage disposed separately from the processor 1001. In this case, the processor 1001 may access the memory 1002 via an I/O interface which is not illustrated.

In the example of FIG. 19, the memory 1002 is used for accommodating software modules. The processor 1001 reads the software modules from the memory 1002, executes the read software modules, and thereby can process the communication device 1 and the like described according to the above-described example embodiments.

As described by using FIG. 19, each of processors included in the communication device 1 and the like executes one or a plurality of programs including instructions for causing a computer to execute the algorithms described by using the drawings.

In the above-described examples, a program can be stored by using various types of non-transitory computer readable media and supplied to a computer. The non-transitory computer readable medium includes various types of tangible storage media. The non-transitory computer readable medium includes, for example, a magnetic recording medium (e.g., a flexible disk, a magnetic tape, and a hard disk derive) and a magneto optical recording medium (e.g., a magneto optical disc). The non-transitory computer readable medium further includes, for example, a CD-read only memory (ROM), a CD-R, and a CD-R/W. The non-transitory computer readable medium further includes, for example, a semiconductor memory. The semiconductor memory includes, for example, a mask ROM, a programmable ROM (PROM), an erasable PROM (EPROM), a flash ROM, and a random access memory (RAM). A program may be supplied to a computer by using various types of transitory computer readable media. The transitory computer readable medium includes, for example, an electric signal, an optical signal and an electromagnetic wave. The transitory computer readable medium can supply a program to a computer via a wired communication path such as an electric line and an optical fiber or a wireless communication path.

While the disclosure has been particularly shown and described with reference to example embodiments thereof, the disclosure is not limited to these embodiments. It will be understood by those of ordinary skill in the art that various changes in form and details may be made therein without departing from the spirit and scope of the present disclosure as defined by the claims.

The whole or part of the example embodiments disclosed above can be described as, but not limited to, the following supplementary notes.

### (Supplementary Note 1)

A first communication device, among the first communication device and a second communication device that are connected to each other via an interface and include base station functions disposed in a distributed manner, the first communication device comprising:
a reception means for receiving, via the interface, information necessary for beam forming from the second communication device;
a parameter calculation means for calculating, each time information necessary for the beam forming is received, based on the information necessary for beam pattern forming, a beam forming parameter for forming a beam to be used when a downlink signal received from the second communication device is transmitted to a terminal device; and
a monitoring packet generation means for generating, each time the beam forming parameter is calculated, a monitoring packet including the calculated beam forming parameter and outputting the monitoring packet to the interface.

### (Supplementary Note 2)

The first communication device according to supplementary note 1, wherein
the monitoring packet generation means selects, from among the monitoring packets, a monitoring packet including a beam forming parameter for a beam using a specific frequency band in an entire frequency band to be used by the beam, and outputs the selected monitoring packet to the interface.

### (Supplementary Note 3)

The first communication device according to any one of supplementary notes 1 and 2, wherein the monitoring packet generation means selects, from among the monitoring packets, a monitoring packet including a beam forming parameter for forming a beam used in a specific time of an entire time used for a sequence of communications with the terminal device, and outputs the selected monitoring packet to the interface.

### (Supplementary Note 4)

The first communication device according to any one of supplementary notes 1 to 3, wherein the monitoring packet generation means divides the monitoring packet into a plurality of data units and transmits, to the interface, the plurality of divided data units at least one by one.

### (Supplementary Note 5)

The first communication device according to any one of supplementary notes 1 to 4, wherein
the reception means receives, from the second communication device, a request for transmitting the monitoring packet, and the monitoring packet generation means transmits, according to the request, the monitoring packet to the interface.

### (Supplementary Note 6)

The first communication device according to any one of supplementary notes 1 to 5, wherein the information necessary for the beam forming is channel information.

### (Supplementary Note 7)

The first communication device according to any one of supplementary notes 1 to 6, wherein
the monitoring packet includes a beamforming weight.

### (Supplementary Note 8)

The first communication device according to supplementary note 6, wherein
the monitoring packet includes at least one of the channel information, an eigenvalue decomposition result of the channel information, and an inverse matrix of the channel information.

### (Supplementary Note 9)

A method to be executed by, among a first communication device and a second communication device that are connected to each other via an interface and include base station functions disposed in a distributed manner, the first communication device, the method comprising:
receiving, via the interface, information necessary for beam forming from the second communication device;
calculating, each time information necessary for the beam forming is received, based on the information necessary for beam pattern forming, a beam forming parameter for forming a beam to be used when a downlink signal received from the second communication device is transmitted to a terminal device;
generating, each time the beam forming parameter is calculated, a monitoring packet including the calculated beam forming parameter; and
outputting the monitoring packet to the interface.

### (Supplementary Note 10)

A second communication device, among a first communication device and the second communication device that are connected to each other via an interface and include base station functions disposed in a distributed manner, the second communication device comprising
a transmission means for transmitting, via the interface, information necessary for beam forming and a request for transmitting a monitoring packet, to the first communication device, wherein
the monitoring packet includes a beam forming parameter for forming a beam to be used when a downlink signal is transmitted to a terminal device.

### (Supplementary Note 11)

A method to be executed by, among a first communication device and a second communication device that are connected to each other via an interface and include base station functions disposed in a distributed manner, the second communication device, wherein
the second communication device transmits, to the first communication device, via the interface, information necessary for beam forming and a request for transmitting a monitoring packet, and
the monitoring packet includes a beam forming parameter for forming a beam to be used when a downlink signal is transmitted to a terminal device.

This application is based upon and claims the benefit of priority from Japanese patent application No. 2021-151801, filed on Sep. 17, 2021, the disclosure of which is incorporated herein in its entirety by reference.

### REFERENCE SIGNS LIST

1 to 3, 5 to 7, 9 to 11, 13 to 15 Communication device
4, 8, 12, 16 Interface
21, 31, 61, 71, 101, 111, 141 Reception unit
22, 62, 102, 142 Transmission unit
32, 72, 112 Parameter calculation unit
33, 73, 113 Monitoring packet generation unit
143 Processing unit
151 Channel information reception unit
152 Beam pattern forming instruction information reception unit
153 Channel information storage memory
154 Beam pattern forming operation unit
155 Monitoring packet generation unit
1000 Network interface
1001 Processor
1002 Memory

What is claimed is:

1. A first communication device, among the first communication device and a second communication device that are connected to each other via an interface and include base station functions disposed in a distributed manner, the first communication device comprising:
a memory configured to store instructions; and
at least one processor configured to execute the instructions to perform:
receiving, via the interface, information necessary for beam forming from the second communication device;
calculating, each time information necessary for the beam forming is received, based on the information necessary for the beam forming, a beam forming parameter for forming a beam to be used when a downlink signal received from the second communication device is transmitted to a terminal device; and
generating, each time the beam forming parameter is calculated, a monitoring packet including the calculated beam forming parameter and outputting the monitoring packet to the interface.

2. The first communication device according to claim 1, wherein
the at least one processor is configured to execute the instructions to perform:
selecting, from among the monitoring packets, a monitoring packet including a beam forming parameter for a beam using a specific frequency band in an entire frequency band to be used by the beam, and outputting the selected monitoring packet to the interface.

3. The first communication device according to any one of claim 1, wherein
the at least one processor is configured to execute the instructions to perform:
selecting, from among the monitoring packets, a monitoring packet including a beam forming parameter for forming a beam used in a specific time of an entire time used for a sequence of communications with the terminal device, and outputting the selected monitoring packet to the interface.

4. The first communication device according to claim 1, wherein
the at least one processor is configured to execute the instructions to perform:
dividing, the monitoring packet into a plurality of data units and transmitting, to the interface, the plurality of divided data units at least one by one.

5. The first communication device according to claim 1, wherein
the at least one processor is configured to execute the instructions to perform:
receiving, from the second communication device, a request for transmitting the monitoring packet, and
transmitting, according to the request, the monitoring packet to the interface.

6. The first communication device according to claim 1, wherein the information necessary for the beam forming is channel information.

7. The first communication device according to claim 1, wherein
the monitoring packet includes a beamforming weight.

8. The first communication device according to claim 6, wherein
the monitoring packet includes at least one of the channel information, an eigenvalue decomposition result of the channel information, and an inverse matrix of the channel information.

9. A method to be executed by, among a first communication device and a second communication device that are connected to each other via an interface and include base station functions disposed in a distributed manner, the first communication device, the method comprising:
receiving, via the interface, information necessary for beam forming from the second communication device;
calculating, each time information necessary for the beam forming is received, based on the information necessary for the beam forming, a beam forming parameter for forming a beam to be used when a downlink signal received from the second communication device is transmitted to a terminal device;
generating, each time the beam forming parameter is calculated, a monitoring packet including the calculated beam forming parameter; and
outputting the monitoring packet to the interface.

10. A second communication device, among a first communication device and the second communication device that are connected to each other via an interface and include base station functions disposed in a distributed manner, the second communication device comprising
a memory configured to store instructions; and
at least one processor configured to execute the instructions to perform:
transmitting, via the interface, information necessary for beam forming and a request for transmitting a monitoring packet, to the first communication device, wherein
the monitoring packet includes a beam forming parameter for forming a beam to be used when a downlink signal is transmitted to a terminal device.

11. (canceled)

12. The method according to claim 9, wherein the method comprises:
selecting, from among the monitoring packets, a monitoring packet including a beam forming parameter for a beam using a specific frequency band in an entire frequency band to be used by the beam, and outputting the selected monitoring packet to the interface.

13. The method according to claim 9, wherein the method comprises:
selecting, from among the monitoring packets, a monitoring packet including a beam forming parameter for forming a beam used in a specific time of an entire time used for a sequence of communications with the terminal device, and outputting the selected monitoring packet to the interface.

14. The method according to claim 9, wherein the method comprises:
dividing, the monitoring packet into a plurality of data units and transmitting, to the interface, the plurality of divided data units at least one by one.

15. The method according to claim 9, wherein the method comprises:
receiving, from the second communication device, a request for transmitting the monitoring packet, and
transmitting, according to the request, the monitoring packet to the interface.

16. The method according to claim 9, wherein the information necessary for the beam forming is channel information.

17. The method according to claim 9, wherein
the monitoring packet includes a beamforming weight.

18. The method according to claim 16, wherein
the monitoring packet includes at least one of the channel information, an eigenvalue decomposition result of the channel information, and an inverse matrix of the channel information.
